(19) United States
(12) Patent Application Publication
(10) Pub. No.: US 2014/0067541 A1
(43) Pub. Date: Mar. 6, 2014

(54) METHOD AND DEVICE FOR DISPLAYING INFORMATION

(71) Applicant: Samsung Electronics Co. Ltd., Suwon-si (KR)

(72) Inventor: Seong-min KANG, Seoul (KR)

(73) Assignee: Samsung Electronics Co. Ltd., Suwon-si (KR)

(21) Appl. No.: 14/013,657

(22) Filed: Aug. 29, 2013

(30) Foreign Application Priority Data
Aug. 31, 2012 (KR) 10-2012-0096706

(51) Int. Cl. G06Q 30/02

(52) U.S. Cl. CPC G06Q 30/0261
USPC 705/14.58

(57) ABSTRACT

A method and a device for displaying information are provided. The method includes obtaining, by a movement path obtaining unit, information of a movement path of the terminal, receiving, by a short-range wireless communication unit, through a short-range wireless communication, position information of a server providing advertisement information, transmitting, by an information transmitting unit, to the server, information requesting advertisement, receiving, by an information receiving unit, from the server, advertisement information in response to the request, and displaying, by an advertisement displaying unit, on the terminal the received advertisement information on the basis of the obtained information on the movement path of the terminal.

### CROSS-REFERENCE TO RELATED APPLICATION(S)

This application claims the benefit under 35 U.S.C. §119(a) of a Korean patent application filed on Aug. 31, 2012 in the Korean Intellectual Property Office and assigned Serial No. 10-2012-0096706, the entire disclosure of which is hereby incorporated by reference.

### TECHNICAL FIELD

The present disclosure relates to a method and a device for displaying information. More particularly, the present disclosure relates to a method and a device for providing information on the basis of a movement path of a terminal, wherein the information is obtained through the terminal

### BACKGROUND

Information may be provided to a user of a mobile communication terminal who is located at an arbitrary location while in possession of the mobile communication terminal.

Additionally, a provider of advertising information wants to provide advertising information to users of a plurality of mobile communication terminals. A user of a mobile communication terminal may wish to receive the information that is relevant to the user from a large amount of advertising information.

Additionally, a user's movement path may be estimated from a movement path of a terminal as the user carries the mobile communication terminal.

Accordingly, since advertising information to be displayed on a terminal of a user is selected according to a movement path of a mobile communication terminal, it may be displayed on a mobile communication terminal of an intended user.

Therefore, a need exists for a method and a device for providing information on the basis of a movement path of a terminal, wherein the information is obtained through the terminal.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and a device for displaying advertising information relating to a movement path of a user on the basis of a movement path of a terminal.

In accordance with an aspect of the present disclosure, a method by which a terminal provides an advertisement is provided. The method includes obtaining, by a movement path obtaining unit, information of a movement path of the terminal, receiving, by a short-range wireless communication unit, through a short-range wireless communication, location information of a server providing advertisement information, transmitting, by an information transmitting unit, to the server, information requesting an advertisement, receiving, by an information receiving unit, from the server, advertisement information in response to the request, and displaying, by an advertisement displaying unit, on the terminal the received advertisement information on a basis of the obtained information on the movement path of the terminal.

The obtaining of the information on the movement path of the terminal may include obtaining the information on the movement path based on a location of an information providing device which performs a short-range wireless communication with the terminal.

The method may further include displaying information on a location of the information providing device located within a certain distance from a location of the terminal.

The method may further include receiving, by the terminal, information for connecting to an Access Point (AP) through the short-range wireless communication with the information providing device, and performing data communication through the AP on a basis of the information for connecting to the AP.

The advertisement information may include location information corresponding to the advertisement information, wherein the displaying of the received advertisement information on the terminal comprises determining a position in a screen of the terminal where the advertisement information is to be displayed on a basis of the obtained information on the movement path of the terminal and the location information corresponding to the advertisement information.

The information on the movement path of the terminal may include at least one of a date, a day, a time, a moving frequency, or a transportation use history that relates to the movement path of the terminal.

The displaying of the advertisement information on the terminal may include assigning a priority to the advertisement information, and displaying the advertisement information on the basis of the priority.

The advertisement information may include location information corresponding to the advertisement information.

The assigning of the priority to the advertisement information may include comparing the location information of the advertisement information with the information on the movement path and assigning the priority to the advertisement information according to a comparison result.

The method may further include storing user feedback information including information on an input of a user for the advertisement information displayed on the terminal.

The assigning of the priority to the advertisement information may include assigning the priority to the advertisement information on a basis of the user feedback information.

The method may further include receiving, by the terminal, additional information on the displayed advertisement information from an information providing device through a short-range wireless communication, and changing the displayed advertisement information, on a basis of the received additional information.

In accordance with another aspect of the present disclosure, a method by which a terminal provides an advertisement is provided. The method includes obtaining, by a movement path obtaining unit, information of a movement path of the terminal, receiving, by a short-range wireless communication unit, through a short-range wireless communication, location information of a server providing advertisement information, transmitting, by an information transmitting unit, information requesting an advertisement, wherein the transmitted information includes the obtained information on the movement path, receiving, by an information receiving unit, from the server, advertisement information selected according to the obtained information on the movement path, and displaying, by an advertisement displaying unit, the received advertisement information on the terminal.

The obtaining of the information on the movement path of the terminal may include obtaining information on the movement path of the terminal based on a location of an information providing device which performs a short-range wireless communication with the terminal.

The method may further include transmitting, to the server, location information of the terminal, and receiving, from the server, information on a location of the information providing device according to a location of the terminal and displaying the received information on the location of the information providing device.

The method may further include receiving, by the terminal, information for connecting to an AP through the short-range wireless communication with the information providing device, and performing data communication through the AP on a basis of the information for connecting to the AP.

The advertisement information may include location information, wherein the displaying of the received advertisement information comprises determining a position in a screen of the terminal where the advertisement information is to be displayed on a basis of the obtained information on the movement path of the terminal and location information included in the advertisement information.

The information on the movement path of the terminal may include at least one of a date, a day, a time, a moving frequency, or a transportation use history that relates to the movement path of the terminal.

The displaying of the advertisement information on the terminal may include assigning a priority to the advertisement information, and displaying the advertisement information on the basis of the priority.

The advertisement information may include location information, wherein the assigning of the priority to the advertisement information comprises comparing the location information corresponding to the advertisement information with the information on the movement path of the terminal and assigning a priority to the advertisement information according to a comparison result.

The method may further include storing user feedback information, that is, information on an input of a user for the displayed advertisement information, wherein the assigning of the priority to the advertisement information comprises assigning the priority to the advertisement on a basis of the user feedback information.

The method further may include receiving, by the terminal, additional information on the displayed advertisement information from an information providing device through a short-range wireless communication, and changing the displayed advertisement information, on a basis of the received additional information.

In accordance with another aspect of the present disclosure, a method by which a server provides an advertisement to a terminal is provided. The method includes obtaining and storing, by an advertisement information collecting unit, advertisement information, receiving, by a movement path receiving unit, from the terminal, information of a movement path of the terminal, selecting, by a data selecting unit, from among the stored advertisement information, advertisement information to be transmitted to the terminal, wherein the selecting of the advertisement information is according to the received information on the movement path of the terminal, and transmitting, by an advertisement transmitting unit, the selected advertisement information to the terminal.

The server may store information on a location of an information providing device capable of transmitting information to the terminal through a short-range wireless communication. The method may further include receiving, from the terminal, location information of the terminal, and transmitting, to the terminal, information on the location of the information providing device when the information providing device is within a certain distance from the received location of the terminal.

In accordance with another aspect of the present disclosure, a method by which a terminal provides an advertisement is provided. The method includes obtaining, by a movement path obtaining unit, information of a movement path of the terminal, transmitting, by an information transmitting unit, through a short-range wireless communication, the obtained information on the movement path to an information providing device, and receiving, by an information receiving unit, from the information providing device, advertisement information according to the transmitted information on the movement path and displaying the received advertisement information.

In accordance with another aspect of the present disclosure, an advertisement providing terminal is provided. The terminal includes a movement path obtaining unit configured to obtain information of a movement path of the terminal, a short-range wireless communication unit configured to receive, through a short-range wireless communication, location information of a server providing advertisement information, an information transmitting unit configured to transmit, to the server, information requesting advertisement, an information receiving unit configured to receive, from the server, advertisement information, and an advertisement displaying unit configured to select advertisement information to be displayed on a basis of the obtained information on the movement path of the terminal that the movement path obtaining unit obtains and the advertisement information that the information receiving unit receives, and display the selected advertisement information.

The short-range wireless communication unit may perform the short-range wireless communication with an information providing device, and the movement path obtaining unit obtains the information on the movement path of the terminal as the short-range wireless communication unit performs the short-range wireless communication with the information providing device.

The information transmitting unit may transmit, to the server, location information of the terminal, the advertisement providing terminal may receive, from the server, information on a location of the information providing device according to the location of the terminal. And the advertisement providing terminal may further include an information providing device position displaying unit configured to display the received information on the location of the information providing device on the terminal.

The short-range wireless communication unit may receive information for connecting to an AP from the information providing device, and the advertisement providing terminal may further include a network connection unit configured to perform data communication with the AP on a basis of the information for accessing the AP.

The advertisement information may include location information and the advertisement displaying unit determines a position in a screen of the terminal where the advertisement information is to be displayed on a basis of the obtained information on the movement path of the terminal and the location information included in the advertisement information.

The information on the movement path of the terminal may include at least one of a date, a day, a time, a moving frequency, or a transportation use history that relates to the movement path of the terminal.

The advertisement providing terminal may further include a priority assignment unit configured to assign a priority to the advertisement information, and the advertisement displaying unit selects advertisement information to be displayed on a basis of the priority assigned to the advertisement information and displays the selected advertisement information on a terminal.

The advertisement information may include location information, and the priority assignment unit compares the location information in the advertisement information with the information on the movement path of the terminal and assigns a priority on the advertisement information according to a comparison result.

The advertisement providing terminal may further include a feedback information obtaining unit configured to obtain user reaction information according to an input of a user for an advertisement information displayed through the advertisement displaying unit, and the priority assignment unit assigns a priority to the advertisement information on a basis of the user feedback information.

The short-range wireless communication unit receives additional information on the advertisement information displayed through the advertisement display unit, from an information providing device, and the advertisement display unit may change the displayed advertisement information, according to the received additional information.

In accordance with another aspect of the present disclosure, an advertisement providing terminal is provided. The terminal includes a movement path obtaining unit configured to obtain information of a movement path of the terminal, a short-range wireless communication unit configured to receive, through a short-range wireless communication, location information of a server providing advertisement information, an information transmitting unit configured to transmit, to the server, information requesting an advertisement and the information on the movement path of the terminal, an information receiving unit configured to receive, from the server, advertisement information based on the transmitted movement path, and an advertisement displaying unit configured to display the received advertisement information.

In accordance with another aspect of the present disclosure, a server providing an advertisement to a terminal is provided. The server includes an advertisement information collecting unit configured to obtain and store advertisement information including location information, a movement path receiving unit configured to receive, from the terminal, information of a movement path of the terminal, a data selecting unit configured to select, from among the advertisement information, advertisement information to be transmitted to the terminal according to a comparison result of the received information on the movement path of the terminal and the location information included in the advertisement information, and an advertisement transmitting unit configured to transmit the selected advertisement information to the terminal.

In accordance with another aspect of the present disclosure, a computer readable recording medium having a program recorded thereon is provided. The computer readable recording medium includes commands that, when executed by a computer, implement the method.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will become more apparent from the following description taken in conjunction with the accompanying drawings, in which:

FIG. 1 is a flowchart illustrating a process for providing advertisement according to an embodiment of the present disclosure;

FIG. 2 is a flowchart illustrating a process for providing advertisement according to an embodiment of the present disclosure;

FIG. 3 is a view illustrating a user interface to receive information of a movement path corresponding to each day or an area of interest from a user according to an embodiment of the present disclosure;

FIG. 4 is a view illustrating a user interface to receive information of a movement path corresponding to each date or an area of interest from a user according to an embodiment of the present disclosure;

FIG. 5 is a view illustrating a user interface to receive information of a movement path of each time or an area of interest from a user according to an embodiment of the present disclosure;

FIG. 6 is a flowchart illustrating a process of a terminal displaying information on a location of an information providing device nearby the terminal and obtaining information of a movement path of the terminal through a short-range wireless communication with the information providing device according to an embodiment of the present disclosure;

FIG. 7 is a view illustrating a screen where a terminal displays information on a location of an information providing device nearby the terminal according to an embodiment of the present disclosure;

FIG. 8 is a flowchart illustrating a process of a terminal accessing an access point through a short-range wireless communication with an information providing device and obtaining information of a movement path according to an embodiment of the present disclosure;

FIG. 9 is a view of when a terminal displays advertisement information on a screen according to a determined position in a screen of the terminal where advertisement information is to be displayed based on a movement path of the terminal and location information matching the advertisement information according to an embodiment of the present disclosure;

FIG. 10 is a view illustrating a process of a terminal determining a priority on advertisement information according to position information matching advertisement information and information of a movement path of the terminal and displaying the advertisement information according to an embodiment of the present disclosure;

FIG. 11 is a view of when a terminal displays advertisements on the basis of priority according to an embodiment of the present disclosure;

FIG. 12 is a view illustrating a process of comparing location information matching advertisement information with information of a movement path of a terminal according to an embodiment of the present disclosure;

FIG. 13 is a view illustrating a process of comparing location information matching advertisement information with information of a movement path of a terminal according to an embodiment of the present disclosure;

FIG. 14 is a flowchart of when a terminal displays advertisement information according to user feedback information on advertisement information displayed on the terminal according to an embodiment of the present disclosure;

FIG. 15 is a flowchart illustrating a process of a terminal changing a display of advertisement information after receiving additional information from an information providing device according to an embodiment of the present disclosure;

FIG. 16 is a view illustrating a process of a terminal changing a display of advertisement information after receiving additional information from an information providing device according to an embodiment of the present disclosure;

FIG. 17 is a view illustrating a process of a server providing advertisement information to a terminal according to an embodiment of the present disclosure;

FIG. 18 is a view illustrating a process of a server transmitting information on a location of an information providing device nearby a terminal according to an embodiment of the present disclosure;

FIG. 19 is a view illustrating a structure of a terminal according to an embodiment of the present disclosure;

FIG. 20 is a view illustrating a structure of a server according to an embodiment of the present disclosure; and

FIG. 21 is a view illustrating a system in which a terminal displays an advertisement according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

In this disclosure below, when one part (or an element, a device, and the like) is referred to as being ‘connected’ to another part (or an element, a device, and the like), it should be understood that the former can be ‘directly connected’ to the latter, or ‘electrically connected’ to the latter via an intervening part (or an element, a device, and the like). Moreover, throughout the specification, the meaning of “include”, “comprise”, “including”, or “comprising” specifies a property, a region, a fixed number, a step, a process, an element and/or a component but does not exclude other properties, regions, fixed numbers, steps, processes, elements and/or components.

As used herein, the term “and/or” includes any and all combinations of one or more of the associated listed items. Expressions, such as “at least one of,” when preceding a list of elements, modify the entire list of elements and do not modify the individual elements of the list.

The present disclosure will be described with reference to the accompanying drawings.

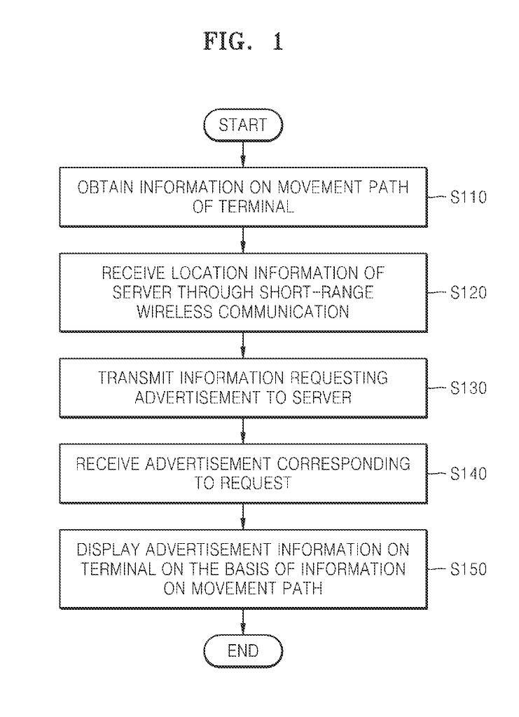

FIG. 1 is a flowchart illustrating a process for providing advertisement according to an embodiment of the present disclosure.

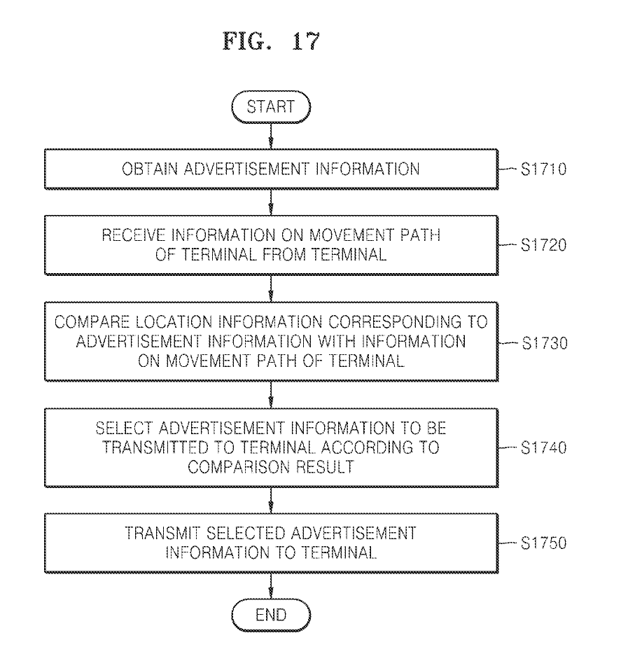

Referring to FIG. 1, a terminal, such as terminal 1600 of FIG. 16, obtains information of a movement path of the terminal 1600 in operation S110. Here, the information on the movement path of the terminal 1600 may be directly inputted by a user through a user interface. Alternatively, the terminal 1600 may obtain information of a movement path from Global Positioning System (GPS) coordinates or information received from another device.

Here, for example, the terminal 1600 may be an electronic device capable of display and communication, such as a mobile phone or a tablet Personal Computer (PC). Alternatively, information of a movement path of a terminal 1600 may include at least one of a movement path related date, a day, a time, a moving frequency, or a transportation use history of the terminal 1600.

According to an embodiment of the present disclosure, the terminal 1600 receives information on a departure, a stop, and a destination through a user interface to obtain information of a movement path. Here, the information on the movement path may be inputted according to a date, a day, or a time.

Additionally, according to another embodiment of the present disclosure, the terminal 1600 may obtain information of a movement path including a region of user interest by receiving an input of information on a location of the terminal through a user interface. Here, the information on the movement path may be inputted according to a date, a day, or a time.

Additionally, according to another embodiment of the present disclosure, information of a movement path may be obtained as a short-range wireless communication with an information providing device 1610 is performed. Here, the information providing device 1610 may be a device for providing information to the terminal 1600 through a short-range wireless communication, such as a Near Field Communication (NFC) tag, a Point-of-Sale (POS) terminal for short-range wireless communication, a Kiosk, and the like.

For example, when a user makes a payment for boarding a bus by using a portable terminal through a wireless communication with a payment device in the bus, the portable terminal may receive location information of the bus and information of a movement path of the bus from the payment device. The portable terminal may obtain information of a movement path of the portable terminal on the basis of the location information of the bus and the information on the movement path of the bus.

Here, the location information may be identification information for identifying a GPS coordinate or a position.

Additionally, for example, while the terminal 1600 performs short-range wireless communication with a Kiosk installed at a station for car sharing for using a car, a user may receive the information on the location of the Kiosk. When the terminal performs short-range wireless communication with the Kiosk to return a vehicle after vehicle use, the portable terminal may receive the information on the location of the Kiosk. Thereafter, the portable terminal may obtain information of a path including information of the location of the Kiosk. The terminal 1600 determines that the location of the terminal 1600 is the location of the Kiosk.

Here, the short-range wireless communication refers to a communication for exchanging information between various information processing devices located within a close range by using an information transmission medium, such as an electromagnetic wave. Examples of the short-range wireless communication include communication within a Local Area Network (LAN), communication via the Bluetooth wireless interface specification, communication related to an Infrared Data Association (IrDA), a HomeRadio Frequency (HomeRF) standard communication, and an NFC.

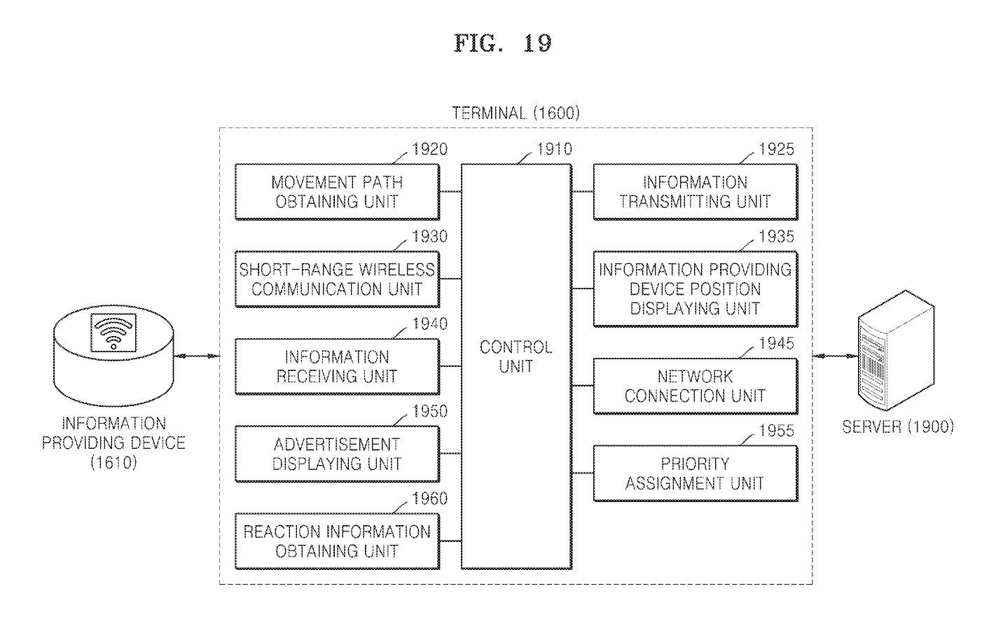

Thereafter, the terminal 1600 may receive the location information of a server, such as server 1900 of FIG. 19, through a short-range wireless communication. Here, the location information of the server 1900 may include information for accessing the server 1900. For example, a Uniform Resource Locator (URL) address for accessing the server 1900 may be included in the location information of the server 1900.

Moreover, according to an embodiment of the present disclosure, the terminal 1600 may receive the location information of the server 1900 through a short-range wireless communication with the information providing device 1610 in operation S120. Here, the information providing device 1610 means a short-range wireless communication available terminal. For example, the information providing device 1610 may be a payment terminal installed in a bus. Alternatively, the information providing device 1610 may be a short-range wireless communication available advertisement providing terminal installed at a bus stop.

Thereafter, the terminal 1600 may transmit information for requesting an advertisement to the server 1900 in operation S130. The terminal 1600 may transmit information for requesting an advertisement to the server 1900 through an additional network, instead of the information providing device 1610.

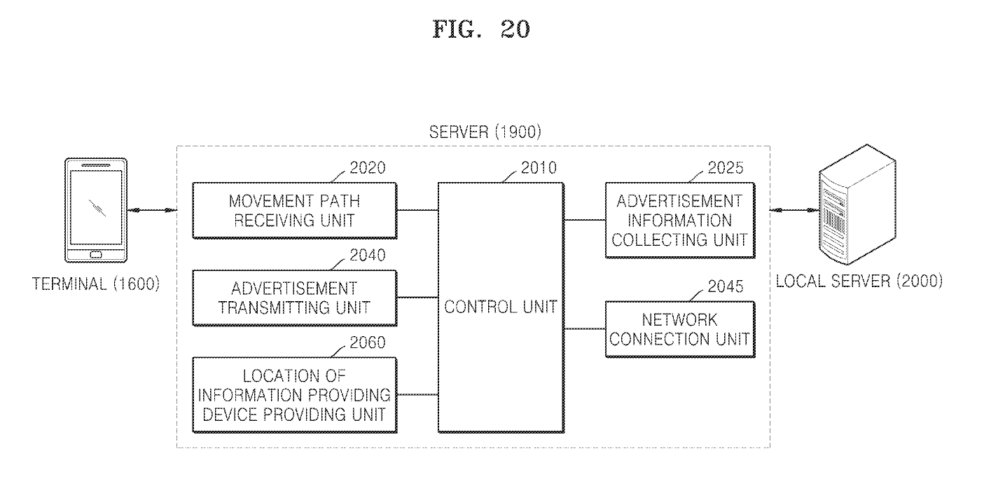

Thereafter, the terminal 1600 may receive advertisement information corresponding to the information for requesting an advertisement in operation S140. Here, the advertisement information may include an advertisement to be displayed on a terminal or link information for accessing an advertisement to be displayed on a terminal. When advertisement information includes link information, the terminal 1600 may access a local server, such as server 2000 of FIG. 20, where an advertisement is stored, by using the link information to display the advertisement information. Moreover, the advertisement information may include metadata on advertisement information, such as a category on advertisement information. For example, the metadata on advertisement information may include information on which category of a restaurant, a movie theater, and a hospital is indicated by the advertisement information.

Here, according to an embodiment of the present disclosure, the terminal 1600 may receive advertisement information from the server 1900 or may receive advertisement information from the information providing device 1610 through a short-range wireless communication.

For example, while boarding a bus, a user may pay a bus fare with a mobile phone that communicates with the bus fare payment terminal via short-range wireless communication, advertisement information may be received from a bus fare payment terminal or the Kiosk

Thereafter, the terminal 1600 may display on a terminal the advertisement information on the basis of the received advertisement information and the obtained movement path of the terminal 1600 in operation S150. Additionally, the advertisement information may include location information that matches the advertisement information.

According to an embodiment of the present disclosure, the terminal 1600 may display on the terminal 1600 the advertisement information whose distance from the movement path to the location information matching the advertisement information is less than a certain distance.

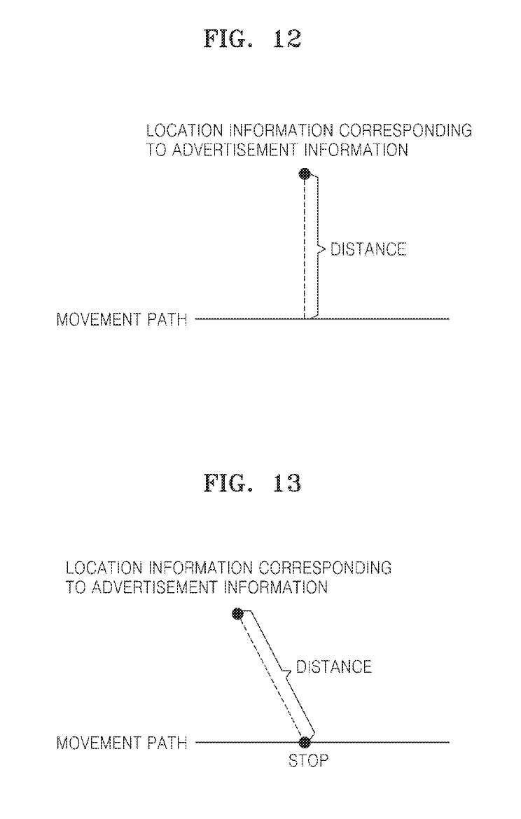

Here, for example, as shown in FIG. 12, the shortest distance from the movement path to the location information matching the advertisement information may be set as the distance from the movement path to the location information matching the advertisement information. Alternatively, as shown in FIG. 13, the distance from arbitrary points in the movement path to the location information corresponding to the advertisement information may be set as the distance from the movement path to the location information corresponding to the advertisement information.

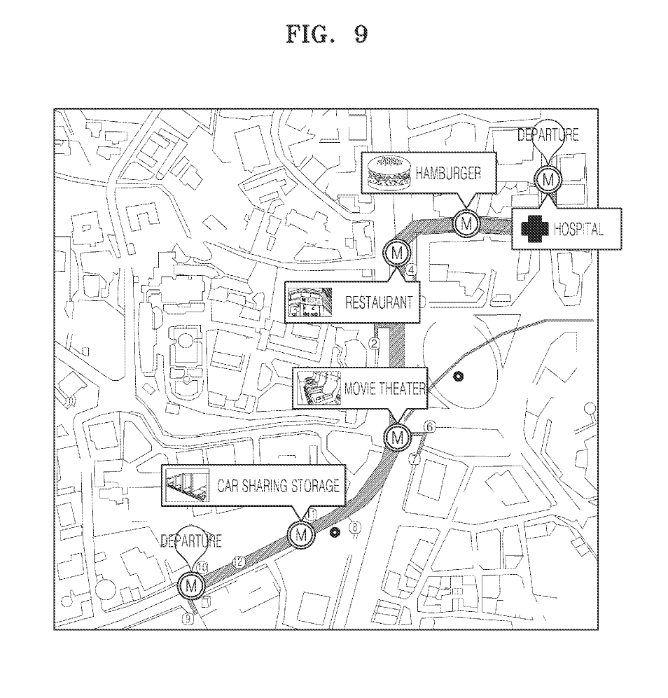

Moreover, according to an embodiment of the present disclosure, the terminal 1600 may determine the position in a screen of the terminal 1600 where advertisement information is to be displayed according to the movement path of the terminal 1600 and the location information matching the advertisement information. For example, as shown in FIG. 9, the advertisement information may be displayed at the point closest to the location information corresponding to the advertisement information in the movement path of the terminal 1600.

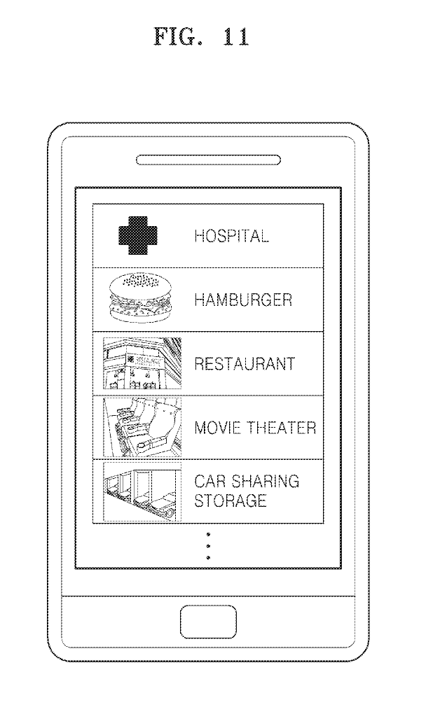

Moreover, according to an embodiment of the present disclosure, the terminal 1600 may assign a priority to the advertisement information and displays the advertisement information according to the assigned priority. For example, as shown in FIG. 11, a plurality of advertisements information may be sequentially displayed according to a priority. Alternatively, advertisement information of higher than a certain priority may be displayed on the terminal 1600.

Moreover, according to another embodiment of the present disclosure, after displaying the advertisement information, the terminal 1600 may change the advertisement information displayed thereon according to information received through a short-range wireless communication with the information providing device 1610. For example, after a coupon for a restaurant is displayed on a mobile phone, a user may receive information on a coupon redemption price from an NFC tag installed in a corresponding restaurant through a short-range wireless communication. Thereafter, the coupon redemption price may be displayed on the mobile phone.

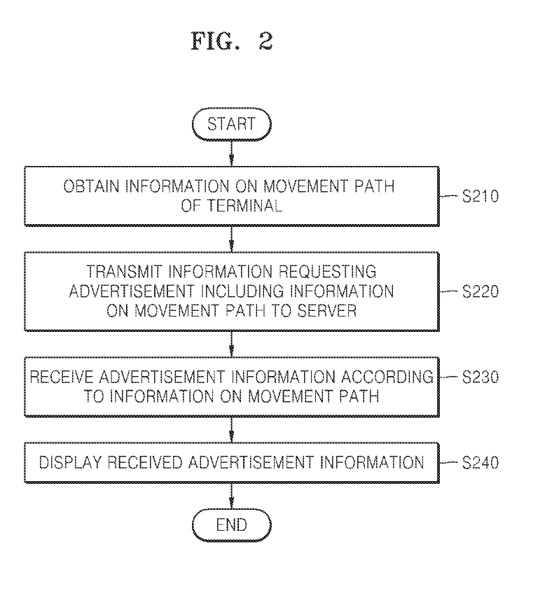

FIG. 2 is a flowchart illustrating a process for providing advertisement according to an embodiment of the present disclosure.

Referring to FIG. 2, the terminal 1600 obtains information of a movement path of the terminal 1600 in operation S210. Here, the information on the movement path of the terminal 1600 may be directly inputted by a user through a user interface. Alternatively, the terminal 1600 may obtain information of a movement path from GPS coordinates or information received from another device.

According to an embodiment of the present disclosure, the terminal 1600 receives information on a departure, a stop, and a destination through a user interface to obtain information of a movement path. Here, the information on the movement path may be inputted according to a date, a day, or a time.

Moreover, according to another embodiment of the present disclosure, the terminal 1600 may obtain information of a movement path including a region of user interest by receiving an input of information of a location through a user interface. Here, the information on the movement path may be inputted according to a date, a day, or a time.

Additionally, according to another embodiment of the present disclosure, information of a movement path may be obtained as a short-range wireless communication with an information providing device 1610. Here, the information providing device 1610 may be a device for providing information to the terminal 1600 through a short-range wireless communication, such as an NFC tag, a POS terminal for short-range wireless communication, a Kiosk, and the like.

Here, the location information may be identification information for identifying a GPS coordinate or a position of the terminal 1600.

Thereafter, the terminal 1600 may transmit information for requesting an advertisement to the server 1900 in operation 5220. Here, the terminal 1600 may transmit information for requesting an advertisement to the information providing device 1610 through a short-range wireless communication. Alternatively, the terminal 1600 may transmit information for requesting an advertisement to the server 1900.

Thereafter, the terminal 1600 may receive advertisement information selected based on the movement path of the terminal 1600, from the server 1900 in operation 5230.

Here, according to an embodiment of the present disclosure, the terminal 1600 may receive advertisement information from the server 1900 or may receive advertisement information from the information providing device 1610 through a short-range wireless communication.

Thereafter, the terminal 1600 may display the received advertisement information in operation 5240.

According to an embodiment of the present disclosure, the terminal 1600 may display the advertisement information whose distance from the movement path to the location information matching the advertisement information is less than a certain distance.

Here, according to an embodiment of the present disclosure, the terminal 1600 may determine the position in a screen of the terminal 1600 where advertisement information is to be displayed according to the movement path of the terminal 1600 and the location information matching the advertisement information. For example, as shown in FIG. 9, the advertisement information may be displayed at the point closest to the location information matching the advertisement information in the movement path of the terminal 1600.

Moreover, according to an embodiment of the present disclosure, the terminal 1600 may assign a priority to the advertisement information and display the advertisement information according to the assigned priority.

Moreover, according to another embodiment of the present disclosure, after displaying the advertisement information, the terminal 1600 may change the advertisement information displayed thereon according to information received through a short-range wireless communication with the information providing device 1610.

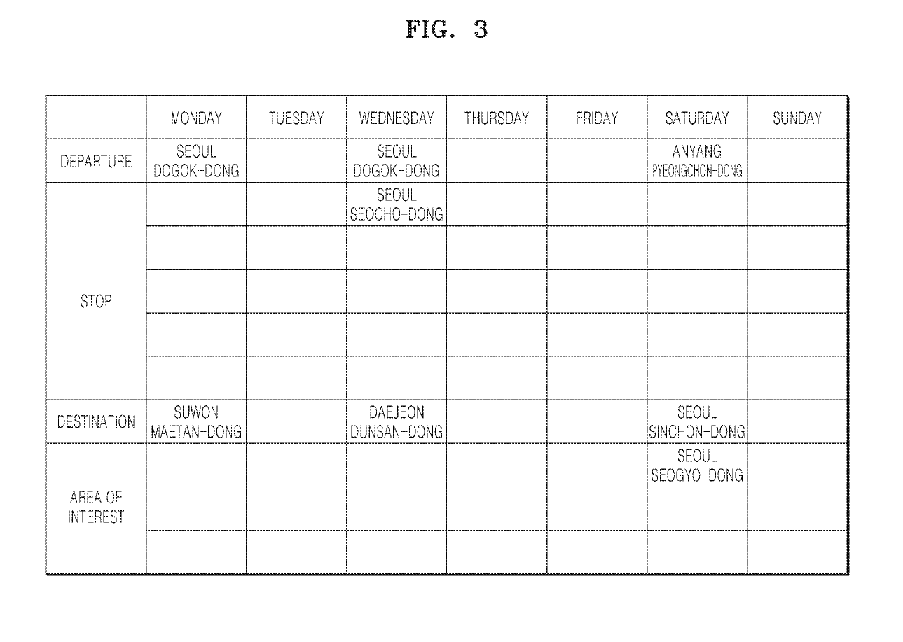

FIG. 3 is a view illustrating a user interface to receive information of a movement path corresponding to each day or a region of interest from a user according to an embodiment of the present disclosure.

Referring to FIG. 3, the terminal 1600 may receive information on a departure, a stop, a destination, and a region of interest corresponding to a day through a user interface. The terminal 1600 may obtain information of a movement path on the basis of the received information on the departure, the stop, the destination, and the region of interest. Moreover, although not shown in FIG. 3, information on transportation may be further received.

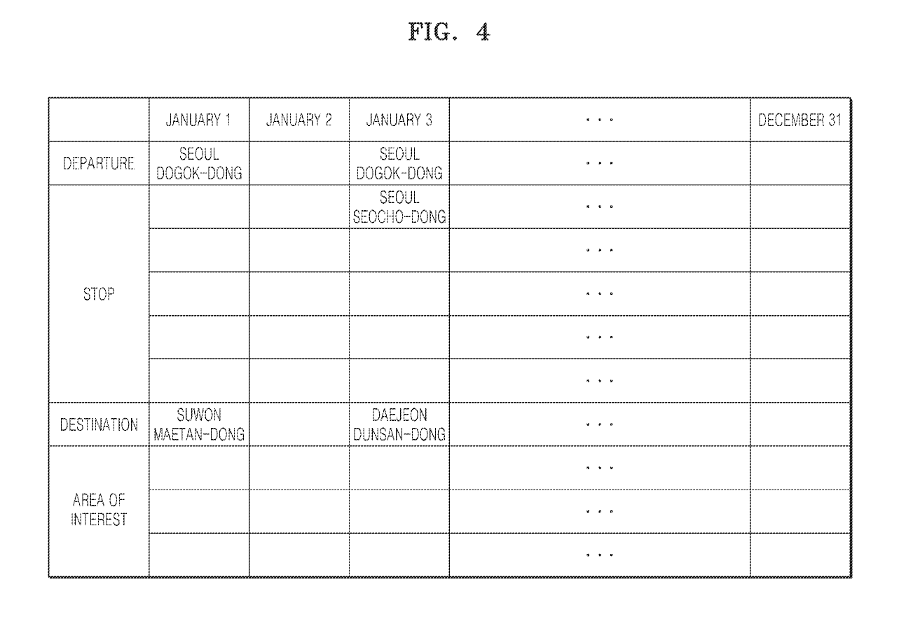

FIG. 4 is a view illustrating a user interface to receive information of a movement path corresponding to a specific date or a region of interest from a user according to an embodiment of the present disclosure.

Referring to FIG. 4, the terminal 1600 may receive information on a departure, a stop, a destination, and a region of interest according to a date through a user interface. The terminal 1600 may obtain information of a movement path on the basis of the received information on the departure, the stop, the destination, and the region of interest. Moreover, although not shown in FIG. 4, information on transportation may be further received.

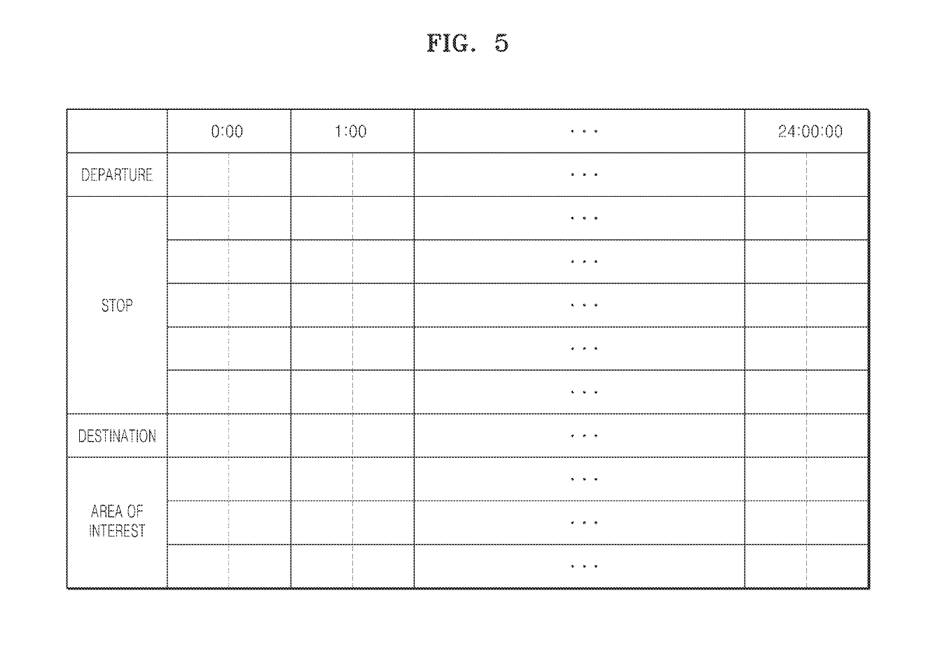

FIG. 5 is a view illustrating a user interface to receive information of a movement path corresponding to each day or a region of interest from a user according to an embodiment of the present disclosure.

Referring to FIG. 5, the terminal 1600 may obtain information on a departure, a stop, a destination, and a region of interest according to a specific time period through a user interface. The terminal 1600 may obtain information of a movement path on the basis of the received information on the departure, the stop, the destination, and the region of interest. Moreover, although not shown in FIG. 5, information related to the type of the transportation used may be further received.

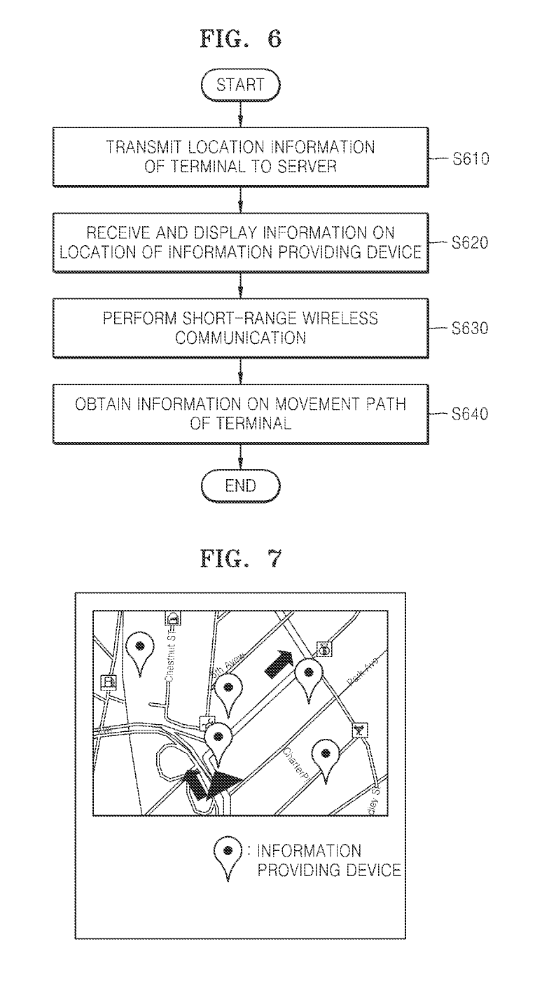

FIG. 6 is a flowchart illustrating a process of a terminal displaying information on a location of an information providing device nearby the terminal and obtaining information of a movement path of the terminal through a short-range wireless communication with the information providing device according to an embodiment of the present disclosure.

Referring to FIG. 6, the terminal 1600 may transmit position information of the terminal 1600 to the server 1900 in operation S610. Thereafter, the terminal 1600 may receive information on the location of the information providing device 1610 nearby the terminal 1600, from the server 1900. The terminal 1600 may display the received location information of the information providing device 1610 in operation S620. Here, although not shown in FIG. 6, instead of receiving the information on the location of the information providing device 1610, the terminal 1600 may display previously-stored information on the location of the information providing device 1610 nearby the terminal 1600 in operations S610 and S620.

Thereafter, while displaying the information on the location of the information providing device 1610 nearby the terminal 1600, a user may be induced to perform a short-range wireless communication with the information providing device 1610 in operation S630. As performing the short-range wireless communication with the information providing device 1610, the terminal 1600 may obtain information of a movement path in operation S640.

FIG. 7 is a view illustrating a screen where a terminal displays information on a location of an information providing device nearby the terminal according to an embodiment of the present disclosure.

Referring to FIG. 7, the terminal 1600 may display information on the location of the information providing device 1610 when the position of the information providing device is located within a certain distance from the location of the terminal 1600. FIG. 7 is used for describing the present disclosure, but embodiments of the present disclosure are not limited thereto.

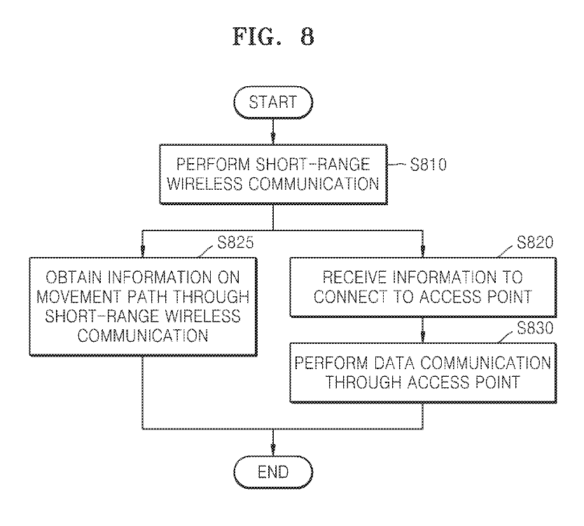

FIG. 8 is a flowchart illustrating a process of a terminal accessing an access point through a short-range wireless communication with an information providing device and obtaining information of a movement path according to an embodiment of the present disclosure.

Referring to FIG. 8, the terminal 1600 may perform a short-range wireless communication with the information providing device 1610 in operation S810. While performing the short-range wireless communication with the information providing device 1610, the terminal 1600 may obtain information of a movement path through the short-range wireless communication in operation S825.

When a user rents a vehicle at a car sharing stop, a short-range wireless communication between a Kiosk installed at the car sharing stop and a mobile phone may be performed. Here, the mobile phone may receive identification information of the Kiosk through the short-range wireless communication. Thereafter, the mobile phone may obtain information on the current location of the mobile phone from the identification information of the Kiosk.

Moreover, the terminal 1600 may receive information for connecting to an access point from the information providing device 1610 in operation S820. Thereafter, the terminal 1600 may perform data communication while connected to the access point on the basis of the received information for accessing the access point in operation S830.

For example, the terminal 1600 receives identification information for the access point and a password for accessing the access point, from the information providing device 1610 and establishes a Wi-Fi communication connection with the access point on the basis of the received information.

As a short-range wireless communication with the information providing device is formed in such a way, a communication connection with the access point is completed. Therefore, a user of the terminal 1600 may be induced to perform a short-range wireless communication with the information providing device 1610.

FIG. 9 is a view of when a terminal displays advertisement information on a screen according to a determined position in a screen of the terminal where advertisement information is to be displayed according to a movement path of the terminal and location information matching the advertisement information according to an embodiment of the present disclosure.

Referring to FIG. 9, the terminal 1600 displays the information on the movement path and also the advertisement information which is located at a point closest to the location information matching the advertisement information in the movement path of the terminal 1600.

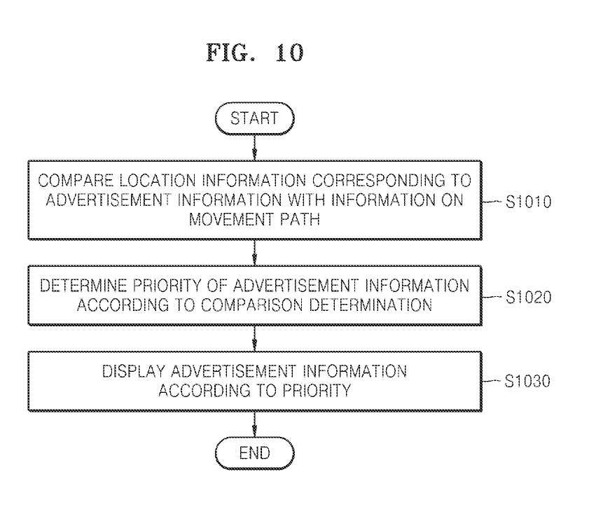

FIG. 10 is a view illustrating a process of a terminal determining a priority of an advertisement according to location information matching advertisement information and information of a movement path of the terminal and displaying the advertisement information according to an embodiment of the present disclosure.

Referring to FIG. 10, the terminal 1600 may compare the location information matching the advertisement information with the information on the movement path in operation S1010. Here, according to an embodiment of the present disclosure, information on a distance from the movement path to the location information corresponding to the advertisement information may be obtained in operation S1010. For example, as shown in FIG. 12, the shortest distance from the movement path to the location information corresponding to the advertisement information may be set as the distance from the movement path to the location information corresponding to the advertisement information. Alternatively, as shown in FIG. 13, the distance from arbitrary points in the movement path to the location information corresponding to the advertisement information may be set as the distance from the movement path to the location information corresponding to the advertisement information.

Additionally, the location information matching the advertisement information may be compared to preference information in the information on the movement path in operation S1010. For example, preference information corresponding to the location information matching the advertisement information may be obtained.

Here, the preference information means information on user preferences regarding advertisement information. For example, information on setting a high priority on advertisement information whose category corresponds to a restaurant may be included in the preference information.

Thereafter, the terminal 1600 may determine a priority of the advertisement information according to a comparison result in operation S1020. For example, a priority may be set according to the distance from the movement path to the location information matching the advertisement information or the preference information corresponding to the location information corresponding to the advertisement information.

Thereafter, the terminal 1600 may display the advertisement information according to a set priority in operation S1030. For example, the advertisement information may include multiple advertisements that are sequentially displayed in order of priority. Alternatively, advertisements having a priority that is higher than a certain threshold may be displayed.

FIG. 11 is a view of when a terminal displays advertisements on the basis of priority according to an embodiment of the present disclosure.

Referring to FIG. 11, the terminal 1600 may sequentially display advertisement according to the priority of the advertisement information.

FIG. 12 is a view illustrating a process of comparing location information corresponding to advertisement information with information of a movement path of terminal according to an embodiment of the present disclosure.

Referring to FIG. 12, the terminal 1600 compares the location information corresponding to the advertisement information with information of a movement path of the terminal 1600, so that the shortest distance from the location information corresponding to the advertisement information to the movement path of the terminal 1600 may be obtained.

FIG. 13 is a view illustrating a method of comparing location information corresponding to advertisement information with information of a movement path of a terminal according to an embodiment of the present disclosure.

Referring to FIG. 13, the terminal 1600 compares the location information corresponding to the advertisement information with the information on the movement path of the terminal 1600, so that a distance from the location information corresponding to the advertisement information to a certain location in the movement path of the terminal 1600 may be obtained. Here, the certain location may be one of a departure, a stop, a destination, a region of interest, a car sharing station, and a subway station.

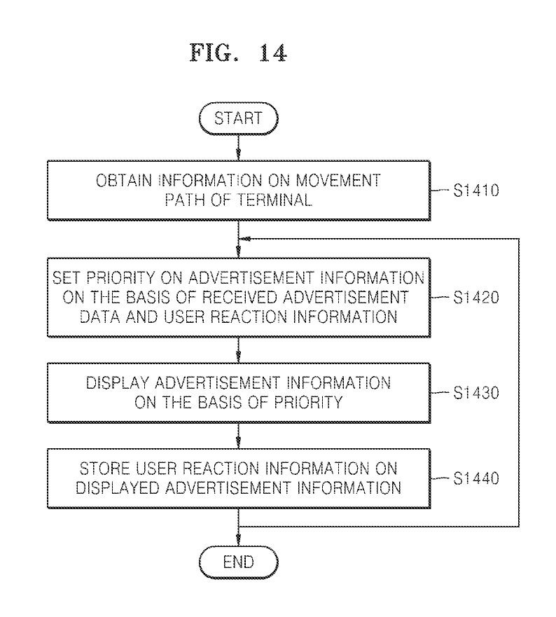

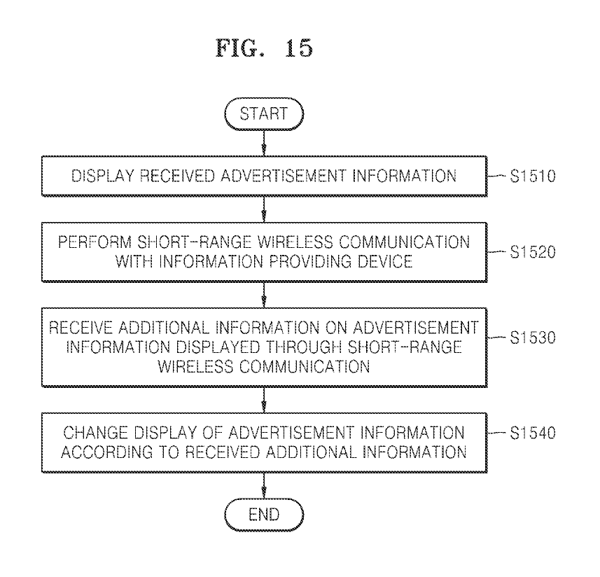

FIG. 14 is a flowchart of when a terminal displays advertisement information according to user feedback information on advertisement information displayed on a terminal according to an embodiment of the present disclosure.

Referring to FIG. 14, the terminal 1600 obtains information of a movement path of the terminal 1600 in operation S1410.

Thereafter, the terminal 1600 may set a priority of the advertisement information on the basis of the received advertisement information and the user feedback information in operation S1420. Here, the user feedback information means information that a user inputs about the advertisement information displayed on the terminal 1600. For example, the user feedback information may include information on actions, such as selecting a link about a web page included in advertisement information displayed on the terminal 1600, selecting advertisement information, deleting advertisement information, or updating advertisement information in a Social Network Service (SNS). The user feedback information may be stored in the terminal 1600.

For example, when a user updates the advertisement information in the terminal 1600 through an SNS, the terminal 1600 may set a high priority on the advertisement information corresponding to location information indicating location within a certain distance from the movement path.

Thereafter, the terminal 1600 may display the advertisement information according to a set priority in operation S1430. Thereafter, the terminal 1600 may store user feedback information on the displayed advertisement information in operation S1440.

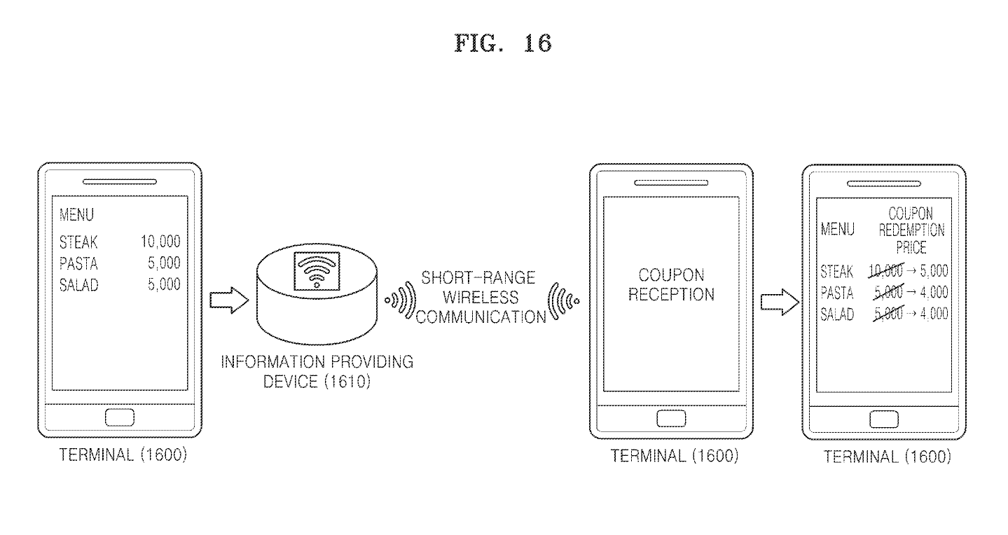

FIG. 15 is a flowchart illustrating a process of a terminal changing a display of advertisement information after receiving additional information from an information providing device according to an embodiment of the present disclosure.

Referring to FIG. 15, the terminal 1600 may display advertisement information received from the server 1900 or the advertisement providing device 1610 in operation S1510. For example, advertisement information indicating that information on a discount coupon of a restaurant has been received may be displayed.

Thereafter, the terminal 1600 may perform a short-range wireless communication with the information providing device 1610 in operation S1520. The terminal 1600 may receive additional information on the advertisement information from the information providing device 1610 through a short-range wireless communication in operation S1530.

For example, the terminal 1600 may perform a short-range wireless communication with the information providing device 1610 installed at the restaurant after receiving the information on the discount coupon of the restaurant. Thereafter, the terminal 1600 may update information on the menu of the restaurant and discount coupon redemption price from the information providing device 1610 installed at the restaurant.

Thereafter, the terminal 1600 may change a display of the advertisement information according to the received additional information in operation S1540. For example, the advertisement information indicating that information on a discount coupon is received, which is displayed on the terminal 1600, may be changed into information on a menu of a restaurant and information on a discount coupon redemption price and displayed.

FIG. 16 is a view illustrating a process of a terminal changing a display of advertisement information after receiving additional information from an information providing device according to an embodiment of the present disclosure.

Referring to FIG. 16, the terminal 1600 may display the advertisement information on a menu. Thereafter, the terminal 1600 may receive additional information on the advertisement information from the information providing device 1610 displaying the advertisement information on the menu. Here, for example, the additional information may be discount coupon information on a restaurant. Thereafter, the terminal 1600 may change a display of the advertisement information on the menu into advertisement information displaying a discounted price.

FIG. 17 is a view illustrating a process of a server providing advertisement information to a terminal according to an embodiment of the present disclosure.

Referring to FIG. 17, the server 1900 obtains advertisement information to be provided to the terminal 1600 in operation S1710. Here, the server 1900 searches for and obtains advertisement information stored in the local server 2000. Alternatively, advertisement information may be obtained by uploading the advertisement information from a device of an advertisement publisher to the server 1900.

Thereafter, the server 1900 obtains information of a movement path of the terminal 1600, from the terminal 1600 in operation S1720. Thereafter, the server 1900 may compare the received advertisement information with the information on the movement path of the terminal 1600 in operation S1730. Thereafter, the server 1900 may select advertisement information to be transmitted to the terminal 1600 on the basis of the comparison result in operation S1740.

According to an embodiment of the present disclosure, the server 1900 may select advertisement information corresponding to location information indicating a location whose distance from the movement path of the terminal 1600 is less than a certain distance, as advertisement information to be transmitted to the terminal 1600.

Thereafter, the server 1900 may transmit the selected advertisement information to the terminal 1600 in operation S1750.

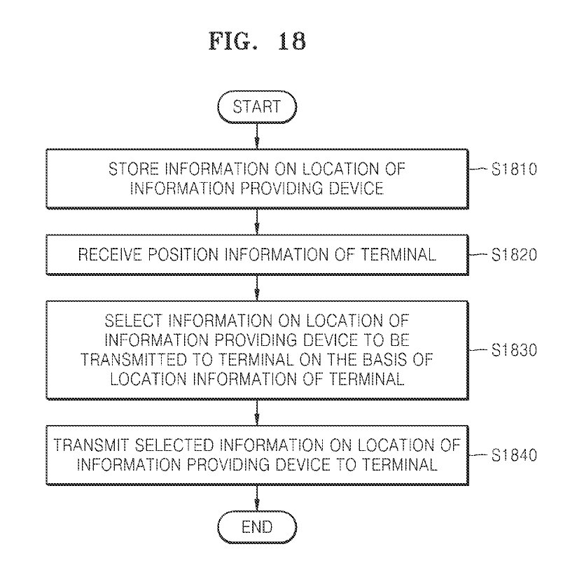

FIG. 18 is a view illustrating a process of a server to transmit information on a location of an information providing device nearby a terminal according to an embodiment of the present disclosure.

Referring to FIG. 18, the server 1900 may store the information on the location of the information providing device 1610 that is available for short-range wireless communication with the terminal 1600 in operation S1810.

Thereafter, while receiving the information on the location of the terminal 1600 from the terminal 1600 in operation S1820, the server 1900 may select the information on the location of the information providing device 1610 to be transmitted to the terminal 1600 on the basis of the location information of the terminal 1600 in operation S1830. For example, if the location of the information providing device 1610 indicates the position of the terminal whose distance from the received location information of the terminal 1600 is less than a certain value, information of the location may be selected as information on the location of the information providing device 1610 to be transmitted to the terminal 1600.

Thereafter, the selected information on the location of the information providing device 1610 may be transmitted to the terminal 1600 in operation S1840. Thereafter, by transmitting the information on the location of the information providing device 1610 to the terminal 1600, the server 1900 may lead to perform short-range wireless communication between the information providing device 1610 and the terminal 1600. Therefore, the terminal 1600 may obtain its location information.

FIG. 19 is a view illustrating a structure of a terminal according to an embodiment of the present disclosure.

Referring to FIG. 19, the terminal 1600 may include a movement path obtaining unit 1920 configured to obtain information of a movement path of the terminal 1600, an information transmitting unit 1925 configured to transmit information of a movement path of the terminal 1600 to the server 1900 or location information of the terminal 1600, a short-range wireless communication unit 1930 configured to perform short-range wireless communication with the information providing device 1610, an information providing device location displaying unit 1935 configured to display the location information of the information providing device 1610, an information receiving unit 1940 configured to receive advertisement information from the server 1900 or the information providing device 1610, a network connection unit 1945 configured to connect a network to an access point on the basis of information for connecting to an access point received from the information providing device 1610, an advertisement displaying unit 1950 configured to display advertisement information on the basis of the received advertisement information and information of a movement path, a priority assignment unit 1955 configured to determine a priority on advertisement information, a feedback information obtaining unit 1960 configured to obtain user feedback information on the displayed advertisement information, and a control unit 1910 controlling each of the components.

FIG. 20 is a view illustrating a structure of a server according to an embodiment of the present disclosure.

Referring to FIG. 20, the server 1900 may include a movement path receiving unit 2020 configured to receive information of a movement path of the terminal 1600 or location information of the terminal 1600, an advertisement information collecting unit 2025 configured to obtain advertisement information, an advertisement transmitting unit 2040, network connection unit 2045 configured to connect to a network, transmitting advertisement information selected by a data selecting unit 2050 (not shown) to the terminal 1600, the data selecting unit 2050 configured to select advertisement information to be transmitted to the terminal 1600 on the basis of information of a movement path of the terminal 1600 and location information corresponding to advertisement information, a location of information providing unit 2060 configured to transmit the location information of the information providing device 1610 located within a certain distance from the location information of the terminal 1600 to the terminal 1600, and a control unit 2010 configured to control each of the components.

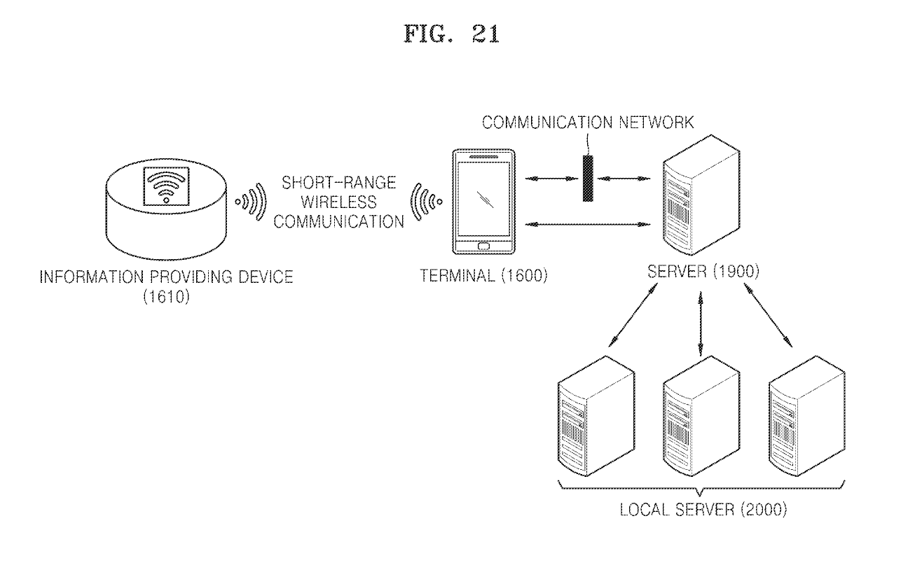

FIG. 21 is a view illustrating a system in which a terminal displays an advertisement according to an embodiment of the present disclosure.

Referring to FIG. 21, the terminal 1600 may receive information of a movement path of the terminal 1600 through a user interface or may obtain information of a movement path of the terminal 1600 through a short-range wireless communication with the information providing device 1610.

Additionally, the terminal 1600 may receive advertisement information from the server 1900 and may display the received advertisement information. Here, advertisement information may be displayed on the basis of the information on the movement path of the terminal 1600.

Additionally, the server 1900 may obtain advertisement information stored in the local server 2000 or advertisement information uploaded by an advertisement publisher. The server 1900 may transmit advertisement information to the terminal 1600. Here, the server 1900 receives information of a movement path of the terminal 1600 and selects advertisement information to be transmitted to the terminal 1600 on the basis of the received information on the movement path.

An embodiment of the present disclosure may be realized in a form of a recording medium including a program module executed by a computer and a command executed by the same computer. A computer readable medium includes an arbitrary available medium and also includes a nonvolatile and a nonvolatile media and a removable and a non-removable media. Additionally, a computer readable medium may include a computer storage medium and a communication medium. The computer storage medium includes a nonvolatile and a nonvolatile media and a removable and a non-removable media, which are realized through an arbitrary method or technique for storing information on a computer readable command, a data structure, a program module, or other data. The communication medium typically includes a computer readable command, a data structure, a program module, or other data of a modulated data signal, such as a carrier.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include Read-Only Memory (ROM), Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method by which a terminal provides an advertisement, the method comprising:
obtaining, by a movement path obtaining unit, information of a movement path of the terminal;
receiving, by a short-range wireless communication unit, through a short-range wireless communication, location information of a server providing advertisement information;
transmitting, by an information transmitting unit, to the server, information requesting an advertisement;
receiving, by an information receiving unit, from the server, advertisement information in response to the request; and
displaying, by an advertisement displaying unit, on the terminal the received advertisement information on a basis of the obtained information on the movement path of the terminal.

2. The method of claim 1, wherein the obtaining of the information on the movement path of the terminal comprises obtaining the information on the movement path based on a location of an information providing device which performs a short-range wireless communication with the terminal.

3. The method of claim 2, further comprising displaying information on a location of the information providing device located within a certain distance from a location of the terminal.

4. The method of claim 2, further comprising:
receiving, by the terminal, information for connecting to an Access Point (AP) through the short-range wireless communication with the information providing device; and
performing data communication through the AP on a basis of the information for connecting to the AP.

5. The method of claim 1, wherein the advertisement information comprises location information corresponding to the advertisement information, and wherein the displaying of the received advertisement information on the terminal comprises determining a position in a screen of the terminal where the advertisement information is to be displayed on a basis of the obtained information on the movement path of the terminal and the location information corresponding to the advertisement information.

6. The method of claim 1, wherein the information on the movement path of the terminal comprises at least one of a date, a day, a time, a moving frequency, or a transportation use history that relates to the movement path of the terminal.

7. The method of claim 1, wherein the displaying of the advertisement information on the terminal comprises:
assigning a priority to the advertisement information; and
displaying the advertisement information on the basis of the priority.

8. The method of claim 7, wherein the advertisement information comprises location information corresponding to the advertisement information, and wherein the assigning of the priority to the advertisement information comprises comparing the location information of the advertisement information with the information on the movement path and assigning the priority to the advertisement information according to a comparison result.

9. The method of claim 7, further comprising storing user feedback information including information on an input of a user for the advertisement information displayed on the terminal, wherein the assigning of the priority to the advertisement information comprises assigning the priority to the advertisement information on a basis of the user feedback information.

10. The method of claim 1, further comprising:
receiving, by the terminal, additional information on the displayed advertisement information from an information providing device through a short-range wireless communication; and
changing the displayed advertisement information on a basis of the received additional information.

11. A method by which a terminal provides an advertisement, the method comprising:
obtaining, by a movement path obtaining unit, information of a movement path of the terminal;
receiving, by a short-range wireless communication unit, through a short-range wireless communication, location information of a server providing advertisement information;
transmitting, by an information transmitting unit, to the server, information requesting an advertisement, wherein the transmitted information includes the obtained information on the movement path;
receiving, by an information receiving unit, from the server, advertisement information selected according to the obtained information on the movement path; and
displaying, by an advertisement displaying unit, the received advertisement information on the terminal.

12. The method of claim 11, wherein the obtaining of the information on the movement path of the terminal comprises obtaining information on the movement path of the terminal based on a location of an information providing device which performs a short-range wireless communication with the terminal.

13. The method of claim 12, further comprising:
transmitting, to the server, location information of the terminal; and
receiving, from the server, information on a location of the information providing device according to a location of the terminal and displaying the received information on the location of the information providing device.

14. The method of claim 12, further comprising:
receiving, by the terminal, information for connecting to an Access Point (AP) through the short-range wireless communication with the information providing device; and
performing data communication through the AP on a basis of the information for connecting to the AP.

15. The method of claim 11, wherein the advertisement information comprises location information, wherein the displaying of the received advertisement information comprises determining a position in a screen of the terminal where the advertisement information is to be displayed on a basis of the obtained information on the movement path of the terminal and location information included in the advertisement information.

16. The method of claim 11, wherein the information on the movement path of the terminal comprises at least one of a date, a day, a time, a moving frequency, or a transportation use history that relates to the movement path of the terminal.

17. The method of claim 11, wherein the displaying of the advertisement information on the terminal comprises:
assigning a priority to the advertisement information; and
displaying the advertisement information on the basis of the priority.

18. The method of claim 17, wherein the advertisement information comprises location information, and wherein the assigning of the priority to the advertisement information comprises comparing the location information corresponding to the advertisement information with the information on the movement path of the terminal and assigning a priority to the advertisement information according to a comparison result.

19. The method of claim 17, further comprising storing user feedback information, that is, information on an input of a user for the displayed advertisement information, wherein the assigning of the priority to the advertisement information comprises assigning the priority to the advertisement on a basis of the user feedback information.

20. The method of claim 11, further comprising:
receiving, by the terminal, additional information on the displayed advertisement information from an information providing device through a short-range wireless communication; and
changing the displayed advertisement information on a basis of the received additional information.

21. A method by which a server provides an advertisement to a terminal, the method comprising:
obtaining and storing, by an advertisement information collecting unit, advertisement information;
receiving, by a movement path receiving unit, from the terminal, information of a movement path of the terminal;
selecting, by a data selecting unit, from among the stored advertisement information, advertisement information to be transmitted to the terminal, wherein the selecting of the advertisement information is according to the received information on the movement path of the terminal; and
transmitting, by an advertisement transmitting unit, the selected advertisement information to the terminal.

22. The method of claim 21, wherein the server stores information on a location of an information providing device capable of transmitting information to the terminal through a short-range wireless communication, further comprising:
receiving, from the terminal, location information of the terminal; and
transmitting, to the terminal, information on the location of the information providing device when the information providing device is within a certain distance from the received location of the terminal.

23. A method by which a terminal provides an advertisement, the method comprising:
obtaining, by a movement path obtaining unit, information of a movement path of the terminal;
transmitting, by an information transmitting unit, through a short-range wireless communication, the obtained information on the movement path to an information providing device; and
receiving, by an information receiving unit, from the information providing device, advertisement information according to the transmitted information on the movement path and displaying the received advertisement information.

24. An advertisement providing terminal, the terminal comprising:
a movement path obtaining unit configured to obtain information of a movement path of the terminal;
a short-range wireless communication unit configured to receive, through a short-range wireless communication, location information of a server providing advertisement information;
an information transmitting unit configured to transmit, to the server, information requesting advertisement;
an information receiving unit configured to receive, from the server, advertisement information; and
an advertisement displaying unit configured to select advertisement information to be displayed on a basis of the obtained information on the movement path of the terminal that the movement path obtaining unit obtains and the advertisement information that the information receiving unit receives, and to display the selected advertisement information.

25. The terminal of claim 24, wherein the short-range wireless communication unit performs the short-range wireless communication with an information providing device, and wherein the movement path obtaining unit obtains the information on the movement path of the terminal as the short-range wireless communication unit performs the short-range wireless communication with the information providing device.

26. The terminal of claim 25, wherein the information transmitting unit transmits, to the server, location information of the terminal,
wherein the advertisement providing terminal receives, from the server, information on a location of the information providing device according to the location of the terminal, and
wherein the advertisement providing terminal further comprises an information providing device position displaying unit configured to display the received information on the location of the information providing device on the terminal.

27. The terminal of claim 25, wherein the short-range wireless communication unit receives information for connecting to an Access Point (AP) from the information providing device, and wherein the advertisement providing terminal further comprises a network connection unit configured to perform data communication with the AP on a basis of the information for accessing the AP.

28. The terminal of claim 24, wherein the advertisement information comprises location information and the advertisement displaying unit determines a position in a screen of the terminal where the advertisement information is to be displayed on a basis of the obtained information on the movement path of the terminal and the location information included in the advertisement information.

29. The terminal of claim 24, wherein the information on the movement path of the terminal comprises at least one of a date, a day, a time, a moving frequency, or a transportation use history that relates to the movement path of the terminal.

30. The terminal of claim 24, wherein the advertisement providing terminal further comprises a priority assignment unit configured to assign a priority to the advertisement information, and wherein the advertisement displaying unit selects advertisement information to be displayed on a basis of the priority assigned to the advertisement information and displays the selected advertisement information on a terminal.

31. The terminal of claim 30, wherein the advertisement information comprises location information, and wherein the priority assignment unit compares the location information in the advertisement information with the information on the movement path of the terminal and assigns a priority on the advertisement information according to a comparison result.

32. The terminal of claim 30, wherein the advertisement providing terminal further comprises a feedback information obtaining unit configured to obtain user reaction information according to an input of a user for an advertisement information displayed through the advertisement displaying unit, and wherein the priority assignment unit assigns a priority to the advertisement information on a basis of the user feedback information.

33. The terminal of claim 24, wherein the short-range wireless communication unit receives additional information on the advertisement information displayed through the advertisement display unit, from an information providing device, and wherein the advertisement display unit changes the displayed advertisement information according to the received additional information.

34. An advertisement providing terminal, the terminal comprising:
a movement path obtaining unit configured to obtain information of a movement path of the terminal;
a short-range wireless communication unit configured to receive, through a short-range wireless communication, location information of a server providing advertisement information;
an information transmitting unit configured to transmit, to the server, information requesting an advertisement and the information on the movement path of the terminal;
an information receiving unit configured to receive, from the server, advertisement information based on the transmitted movement path; and
an advertisement displaying unit configured to display the received advertisement information.

35. A server providing an advertisement to a terminal, the server comprising:
an advertisement information collecting unit configured to obtain and store advertisement information including location information;
a movement path receiving unit configured to receive, from the terminal, information of a movement path of the terminal;
a data selecting unit configured to select, from among the advertisement information, advertisement information to be transmitted to the terminal according to a comparison result of the received information on the movement path of the terminal and the location information included in the advertisement information; and
an advertisement transmitting unit configured to transmit the selected advertisement information to the terminal.

36. A non-transitory computer readable recording medium having a program recorded thereon, which, when executed by a computer, implements the method of claim 1.
